(19) United States
(12) Patent Application Publication
(10) Pub. No.: US 2009/0053470 A1
(43) Pub. Date: Feb. 26, 2009

(54) Method for Preparing Monolithic Separation and Reaction Media in a Separation or Reaction Channel

(76) Inventor: Gert Desmet, Elewijt (BE)

Correspondence Address: KNOBBE MARTENS OLSON & BEAR LLP, 2040 MAIN STREET, FOURTEENTH FLOOR, IRVINE, CA, 92614, US

(21) Appl. No.: 11/886,606

(22) PCT Filed: Mar. 15, 2006
(86) PCT No.: PCT/EP2006/002401

§ 371 Date: Sep. 17, 2007

(30) Foreign Application Priority Data
Mar. 17, 2005 (EP) PCT/EP2005/002883

(51) Int. Cl. B32B 3/00; B05D 3/10

(52) U.S. Cl. 428/156; 427/301

(57) ABSTRACT

The invention provides a method for preparing monolithic separation and reaction media in a separation or reaction channel, characterised in that the separation or reaction channel is first provided with a micro-structured scaffold comprising scaffold skeleton elements, substantially filling the whole channel interior in a substantially uniform way prior to the application of the monolith forming solutions and methods.

### FIELD OF THE INVENTION

The present invention relates to a method for preparing monolithic separation and reaction media and their use in monolithic columns.

### BACKGROUND OF THE INVENTION

Monolithic columns are a powerful new HPLC column format, owing their improved performance to the fact that the pore size and the skeleton size can be controlled independently of each other, hence offering a better compromise between flow resistance and band broadening than packed bed columns. In the art, two main classes of monolithic columns exist: silica monolithic columns, as disclosed in WO 95/03256 and polymer monolithic columns, described by e.g. Hjerten et al. (Nature 356, pp. 810-811, 1992) and Frechet et al (Anal Chem 64, pp. 820-822, 1993). The silica monoliths currently are the preferred monolithic column format of choice, due to their bi-porous structure i.e. macro-pores offering a minimal flow resistance to the mobile phase flow and micro-pores inside the skeleton providing a maximal adsorption capacity.

Recent studies have revealed that the chromatographic performances of even the best known monolithic columns could be much improved if their structural homogeneity could be improved (Vervoort et al., Journal of Chromatography A 1030, 177-186, 2004).

In the literature of lab-on-a-chip devices, many micro-channel systems are described which are filled with monolithic media. None of them however describes a micro-machined array of pillars to induce a spatial order in the formed monolithic skeleton.

### SUMMARY OF THE INVENTION

The present invention concerns a method to produce a three-dimensional monolithic skeleton also referred herein as micro-structured scaffold providing a desirable separative or reactive effect. Said method comprises arranging a micro-structured scaffold into a separation channel or column prior to the application of monolith forming solutions and methods. The homogeneity of the monolithic skeleton is strongly improved by the use of the micro-structured scaffold. Using the regularly spaced lattice structure of the micro-structures scaffold, the spatial constraints imposed upon the demixing processes occurring during the monolith forming process imposes an overall regularity on the formed monolithic skeleton.

The present invention also concerns a reaction or separation channel obtained by a method according to the invention. The present invention also concerns a separation or reaction channel with at least one clearly defined inlet and at least one clearly defined outlet, wherein said separation or reaction channel comprises a micro-structured scaffold comprising scaffold skeleton elements, wherein said scaffold is embedded in a monolithic stationary phase.

The present invention also concerns a monolithic column comprising a reaction or separation channel according to the invention.

The present invention also concerns the use of the channels and columns according to the invention in liquid phase chromatography.

### BRIEF DESCRIPTION OF THE FIGURES

FIG. 1 represents schematic bird's eye views of array of structural homogeneity-inducing micro-pillars (a) before and (b) after application of the monolithic skeleton forming method according to an embodiment of the present invention.

FIG. 2 represents schematic top views of equilateral grid staggering (a) and cubic grid staggering (b) according to embodiments of the present invention.

### DETAILED DESCRIPTION

The present invention concerns a method to produce a three-dimensional monolithic skeleton also referred herein as micro-structured scaffold providing a desirable separative or reactive effect wherein the homogeneity of said monolithic skeleton is strongly improved by arranging a micro-structured scaffold into the separation channel or column prior to the application of the monolith forming solutions and methods.

In particular the present invention provides a method for preparing monolithic separation and reaction media in a separation or reaction channel, characterised in that the separation or reaction channel is first provided with a micro-structured scaffold comprising scaffold skeleton elements, said micro-structured scaffold substantially filling the whole channel interior in a substantially uniform way prior to the application of the monolith forming solutions and methods. This method is suitable to any monolith forming methods known in the art. Non-limiting example of suitable monolith forming solutions and methods for use in combination with the present invention are hydrolytically initiated polycondensation reactions of tetraalkoxysilane, in the presence of poly-ethylene glycol as the porogenic solvent, yielding silica monoliths. Another example is the use of free-radical initiated co-polymerization reactions involving methacrylate esters in combination with a porogenic solvent yielding polymeric monoliths.

As used herein “substantially uniform way” refers to the fact that the micro-structure scaffold provides a regularly spaced lattice structure within the channel.

As used in the specification and the appended claims, the singular forms “a”, “an,” and “the” include plural referents unless the context clearly dictates otherwise. By way of example, “a method” means one method or more than one method.

The recitation of numerical ranges by endpoints includes all numbers and fractions subsumed within that range (e.g. 1 to 5 includes 1, 1.5, 2, 2.75, 3, 3.80, 4, and 5).

The present invention is particularly suited for the development of the two types of monolithic columns currently used in the art of chromatography and lab-on-a-chip reactions: the organic polymer-based monolith and the silica-based monolith. Other types of macro-porous monolithic materials, such as polymerised High Internal Phase Emulsions (polyHIPE), or aerogels and xerogels would however also greatly benefit from the presence of such a regular, order inducing scaffold structure. Monolithic aerogel structures can for example be obtained by first synthesising a wet gel (the so-called alcogel) using sol-gel chemistry, in which a liquid silicate precursor is hydrolysed and condensed into a polysilicate gel. The remaining liquid phase, enclosed in the formed gel network, is then (normally) evacuated by supercritical drying, resulting in the formation of a dry aerogel of pure silica.

To promote any of the steps involved in the monolith forming process and/or to improve the fixation of the monolith to the scaffold, the skeleton of the scaffold can be pre-coated with any desirable chemical substance or materials layer prior to the application of the monolith forming mixtures.

The micro-structured scaffolds for use in the present invention can be obtained using any method capable of providing a sufficient degree of micro-structuring. Such as for example 2-D or 3-D laser ablation, photolithographic etching, and the like. In a preferred embodiment, the solid scaffold elements (=scaffold skeleton) are three-dimensional and their skeleton is sufficiently thin, i.e., its mean thickness is smaller than 20 μm, preferably smaller than 5 μm and even more preferably smaller than 1 μm, to loose a minimum of effective space inside the column (i.e. to minimise the loss of effective space). To provide order on the smallest possible scale, the mean distance between said scaffold skeleton elements is smaller than 100 μm, preferably smaller than 10 μm, and in some cases preferably smaller than 1 μm. Suitable skeleton materials can be any mechanically resistant materials amenable for micro-structuring, non-limiting examples thereof include silicon, metals, inorganics and polymers.

Not many methods in the art of micro-structuring are currently known that can produce large sale 3-D structures with the required skeleton sizes that could fill the entire volume of a capillary or tubular column. Such methods could furthermore be very time consuming and expensive. A preferred embodiment consists of scaffold skeleton elements consisting of a 2-dimensional array of pillars.

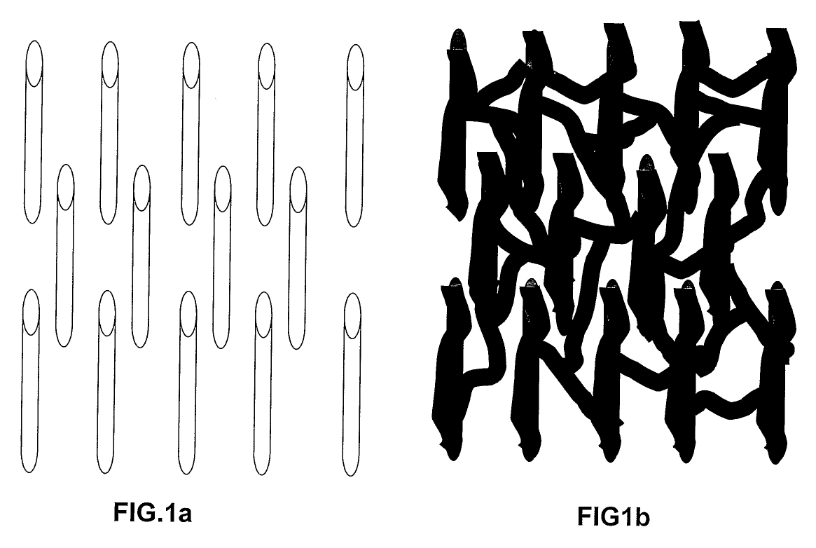

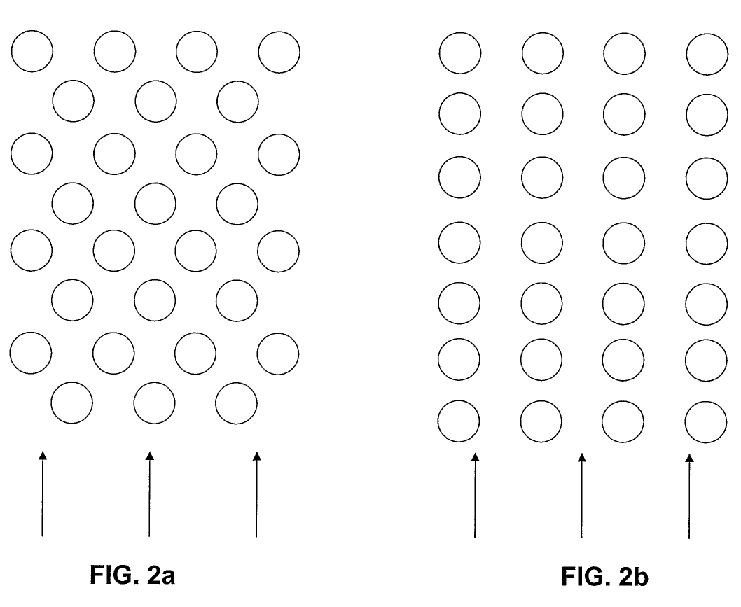

The micro-structured scaffolds or elements, for e.g. the pillars, can be produced using etching Deep Reactive Ion Etching (DRIE) methods. By applying the so-called Bosch process for example, i.e., the etching of silicon followed by a sidewall passivation step, high aspect ratio structures can be obtained. Fine tuning of both the passivation and the etch step in terms of timing, etch gas composition and RF-power, allows to make pillars for use in the present invention with large (i.e., larger than 10) height over width aspect-ratio's. To induce a maximal structural homogeneity, the pillars can be arranged on the corner points of a tiled grid of equilateral triangles, although the method according to the present invention can be also be used with any other suitable pillar arrangement. In a preferred embodiment, the pillars are arranged such that the flow paths which would be followed by a fluid which flowing through the empty pillar array would automatically merge with the adjacent flow paths after each row of pillars. Non-limiting examples of suitable arrangements are shown in FIGS. 2a and 2b, wherein FIG. 2a represents an equilateral grid staggering arrangement and FIG. 2a represents a cubic grid staggering arrangement, with the arrows representing the flow direction when in use. In a preferred embodiment, the arrangement in FIG. 2a is used. The regular merging of flow paths promotes the lateral mixing. In the art of chromatography, it is a highly beneficial feature because it reduces the band broadening. FIG. 1 represents an embodiment of the present invention, wherein is shown an array of structural homogeneity-inducing micro-pillars (FIG. 1a) before and (FIG. 1b) after application of the monolithic skeleton forming method.

Apart from being circular, it is also feasible that other axial cross-sectional shapes for the micro-pillars can be used, including ellipsoidal, hemi-circular, diamond-like, triangular, square, rectangular and hexagonal shapes, and also including all conceivable axially elongated shapes with a length over mean width ratio up to 500:1, and possibly even more. The axially elongated shapes preferably do not run uninterrupted along the entire channel length, thereby allowing the possibility for lateral mixing.

In an embodiment of the present invention, the micro-structured scaffold is obtained by first providing an array of regularly spaced micro-pillars on a first surface, followed by a bonding step with a second surface so that said second surface and said first surface form a flow channel wherein said micro-pillars substantially extend from said first surface to said second surface. In an embodiment, said second surface also contains an array of micro-pillars and wherein the combination of said micro-pillars with the micro-pillars on said first surface substantially fill the entire channel depth.

The present invention encompasses the separation or reaction channels produced by the methods according to the invention. The present invention also encompasses separation or reaction channels provides with a micro-structured scaffold comprising scaffold skeleton elements, wherein said scaffold is embedded in a monolithic stationary phase.

The present invention also encompasses the use of a micro-structured scaffold for the preparation of a monolithic column and further encompasses the monolithic column produced therewith. The micro-structured scaffold may be formed in a column of any size or shape including conventional liquid chromatographic or reaction columns that may be circular cylinders, or coiled, bent or straight capillary tubes, or microchips or having any dimension or geometry.

Therefore the present invention also provides monolithic column comprising a separation or reaction channel obtained by a method according to the present invention. The monolithic column in accordance with the present invention preferably includes a casing (channel) having internal walls provided with a micro-structured scaffold comprising scaffold skeleton elements, wherein said scaffold is embedded in a monolithic stationary phase. In particular, the present invention provides a monolithic column comprising a reaction or separation channel, characterised in that said separation or reaction channel comprises a micro-structured scaffold comprising scaffold skeleton elements, wherein said scaffold is embedded in a monolithic stationary phase. In a preferred embodiment said scaffold skeleton elements comprise an array of regularly spaced micro-pillars. The present invention encompasses organic polymer-based monolithic columns, silica-based monolithic columns as well as macro-porous monolithic columns.

In a preferred embodiment, the mean thickness of the scaffold skeleton elements is smaller than 20 μm, preferably smaller than 5 μm and more preferably smaller than 1 μm, and wherein the mean distance between said scaffold skeleton elements is smaller than 100 μm, preferably smaller than 10 μm, and is some cases preferably smaller than 1 μm.

The axial cross-section of said micro-pillars can be circular, ellipsoidal, hemi-circular, diamond-like, triangular, square, rectangular hexagonal shape or the like, and including all axially elongated shapes with a length over mean width ratio up to 500:1 or more. In a preferred embodiment said cross-section is circular.

Another advantage of the methods and devices according to the present invention, is that, due to the presence of a high density array of anchoring points provided by the micro-structured scaffold, the many problems related to the shrinkage and the swelling of monolithic separation and reaction bodies (occurring both during their manufacturing and their use) can be alleviated.

The channels and the columns according to the invention can be used for performing separations or for participating in chemical reactions. The present columns show improved resolution, capacity and/or flow rate.

The present invention also provides a method for performing a separation of components in a sample. The method comprises contacting the sample with the channels or the columns according of the invention. In one embodiment, the sample is passed through a chromatographic column containing the channels of the invention.

The invention also provides a separation device comprising the chromatographic material of the invention. The invention also provides a reaction device comprising the reaction material of the invention.

In particular, the present invention encompasses the use of the channels and the columns according to the invention in liquid phase chromatography, including but not limited to reversed-phase, normal-phase, adsorption, size-exclusion, affinity, and ion chromatography.

The invention and its advantages are readily understood from the foregoing description. It is apparent that various changes can be made in the method without departing from the spirit and scope of the invention.

1. A method for preparing a monolithic column, comprising the steps of
(a) first arranging a micro-structured scaffold having a regularly spaced lattice structure produced using a micro-structuring method and comprising scaffold skeleton elements substantially filling the whole channel interior in a substantially uniform way, wherein said micro-structured scaffold is obtained by first providing an array of regularly spaced micro-pillars on a first surface, followed by a bonding step with a second surface so that said second surface and said first surface form a flow channel wherein said micro-pillars substantially extend from said first surface to said second surface, and
(b) forming a monolithic column by applying monolith forming mixtures and methods.

2. The method according to claim 1 wherein said second surface also contains an array of micro-pillars and wherein the combination of said micro-pillars with the micro-pillars on said first surface substantially fill the entire channel depth.

3. The method according to claim 1, wherein the scaffold structure is pre-coated with a chemical substance or materials layer suitable to enhance any of the steps involved in the monolith forming process.

4. The method according to claim 1, wherein the mean thickness of the scaffold skeleton elements is smaller than 20 μm, preferably smaller than 5 μm and more preferably smaller than 1 μm, and wherein the mean distance between said scaffold skeleton elements is smaller than 100 μm, preferably smaller than 10 μm, and is some cases preferably smaller than 1 μm.

5. The method according to claim 2 , wherein the axial cross-section of said micro-pillars is circular, ellipsoidal, hemi-circular, diamond-like, triangular, square, rectangular, or hexagonal shape or an axially elongated shapes with a length over mean width ratio up to 500:1 or more.

6. A monolithic column comprising a separation or reaction channel, wherein said separation or reaction channel comprises a micro-structured scaffold having a regularly spaced lattice structure comprising scaffold skeleton elements, wherein said scaffold is embedded in a polymer based, silica-based or macro-porous monolithic material.

7. The monolithic column according to claim 6, wherein said micro-structured scaffold comprise an array of regularly spaced micro-pillars.

8. The monolithic column according to claim 6, wherein the mean thickness of the scaffold skeleton elements is smaller than 20 μm, preferably smaller than 5 μm and more preferably smaller than 1 μm, and wherein the mean distance between said scaffold skeleton elements is smaller than 100 μm, preferably smaller than 10 μm, and is some cases preferably smaller than 1 μm.

9. The monolithic column according to claim 7, wherein the axial cross-section of said micro-pillars is circular, ellipsoidal, hemi-circular, diamond-like, triangular, square, rectangular hexagonal shape or the like, and including all axially elongated shapes with a length over mean width ratio up to 500:1 or more.

10. The method according to claim 2, wherein the scaffold structure is pre-coated with a chemical substance or materials layer suitable to enhance any of the steps involved in the monolith forming process.

11. The method according to claim 2, wherein the mean thickness of the scaffold skeleton elements is smaller than 20 μm, preferably smaller than 5 μm and more preferably smaller than 1 μm, and wherein the mean distance between said scaffold skeleton elements is smaller than 100 μm, preferably smaller than 10 μm, and is some cases preferably smaller than 1 μm.

12. The method according to claim 3, wherein the mean thickness of the scaffold skeleton elements is smaller than 20 μm, preferably smaller than 5 μm and more preferably smaller than 1 μm, and wherein the mean distance between said scaffold skeleton elements is smaller than 100 μm, preferably smaller than 10 μm, and is some cases preferably smaller than 1 μm.

13. The monolithic column according to claim 7, wherein the mean thickness of the scaffold skeleton elements is smaller than 20 μm, preferably smaller than 5 μm and more preferably smaller than 1 μm, and wherein the mean distance between said scaffold skeleton elements is smaller than 100 μm, preferably smaller than 10 μm, and is some cases preferably smaller than 1 μm.

14. The monolithic column according to claim 8, wherein the axial cross-section of said micro-pillars is circular, ellipsoidal, hemi-circular, diamond-like, triangular, square, rectangular hexagonal shape or the like, and including all axially elongated shapes with a length over mean width ratio up to 500:1 or more.
